(19) United States
(12) Patent Application Publication
(10) Pub. No.: US 2011/0023041 A1
(43) Pub. Date: Jan. 27, 2011

(54) PROCESS MANAGEMENT SYSTEM AND METHOD FOR MONITORING PROCESS IN AN EMBEDDED ELECTRONIC DEVICE

(75) Inventor: TENG-YU TSAI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/612,468

(22) Filed: Nov. 4, 2009

(30) Foreign Application Priority Data
Jul. 23, 2009 (CN) 200910304701.3

(51) Int. Cl. G06F 9/46; G06F 12/02

(52) U.S. Cl. 718/102; 711/104; 711/E12.007

(57) ABSTRACT

A checking method for a process in an embedded electronic device includes the following steps. A name of an application is recorded to an application recorder. The application is executed by a system processor. An active application list is acquired from the system processor. An execute control may determine if the name of the recorded application in the application recorder exists in the active application list. If the name of the recorded application does not exist, the system processor may shut down at least one child process related to the application.

### BACKGROUND

1. Technical Field

The disclosure generally relates to process management systems of embedded electronic devices and methods for monitoring processes in embedded electronic devices.

2. Description of Related Art

Nowadays, the embedded electronic devices, such as digital cameras, set-top boxes, digital phone frames etc. have many functions, such as playing multimedia files, reading documents, browsing websites etc. In these embedded electronic devices, many different kinds of programs need to be executed. Some errors may occur between the different kinds of programs when the electronic device is working. For example, when a video playing UI program is executed, the program may be interfered by the other executed programs in a memory, and the video playing UI program may fail. Thus there is need to monitor the programs executed by the system.

### BRIEF DESCRIPTION OF THE DRAWINGS

FIG. 1 is a block view of a process management system of an embedded electronic device according to an embodiment.

FIG. 2 is a flowchart of a method for monitoring a process in an embedded electronic device according to one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

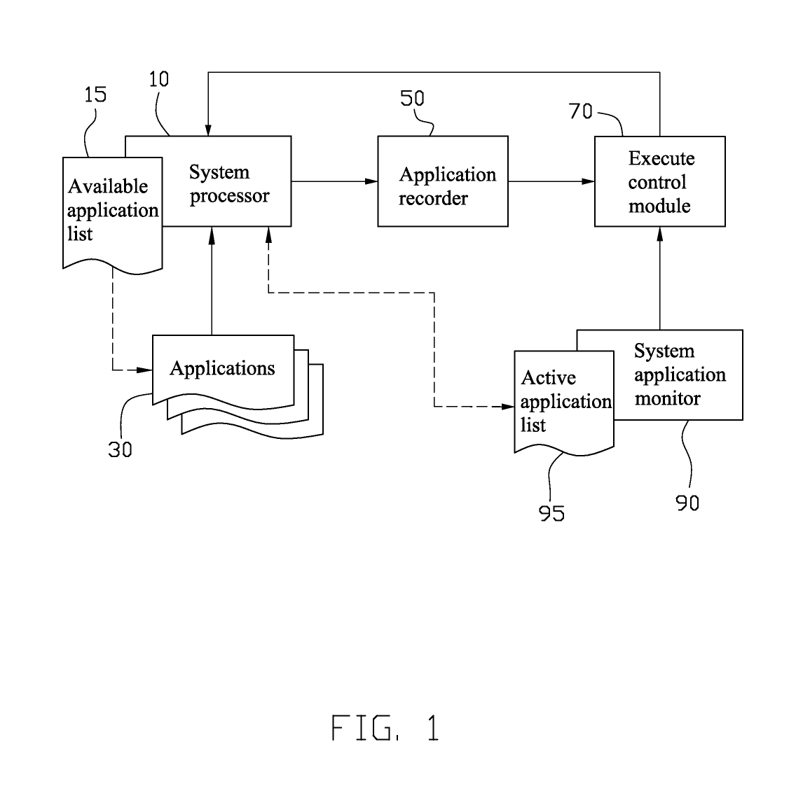

Referring to FIG. 1, a process management system of an embedded system includes a system processor 10, an application recorder 50, an execute control module 70, and a system application monitor 90. The system processor 10 can execute at least one application 30 from at least one application modules. All names of the applications 30 are recorded in an available application list 15. The available application list 15 is stored in the system processor 10. The application 30 can be a video or an audio user interface (UI) application for playing multimedia files. The application recorder 50 can log name of any application to be executed by the system processor 10. The application recorder 50 can be a random-access memory (RAM) disk. The system application monitor 90 can record names of all active processes in the system processor 10. An active application list 95 is stored in the system application monitor 90. The active application list 95 can track the active processes while the system processor 10 is processing. The processes may include a plurality of system applications and applications 30 processed by the system processor 10. It is to be understood that the name of the application is meant to include, but is not limited to, any means of identifying the application.

The application 30 may invoke child processes while the application 30 is successfully being executed by the system processor 10. If the application 30 is terminated by any reasons while executed by the system processor 10, some of the child processes may remain in the system processor 10.

The execute control module 70 can determine if the name of the recorded application in the application recorder 50 exists in the active application list 95 after the application 30 is executed. If the name of the recorded application does not exist, for example the application 30 is terminated by some unknown reasons; the system processor 10 can kill the redundant child processes related to the application 30 and restart the application 30.

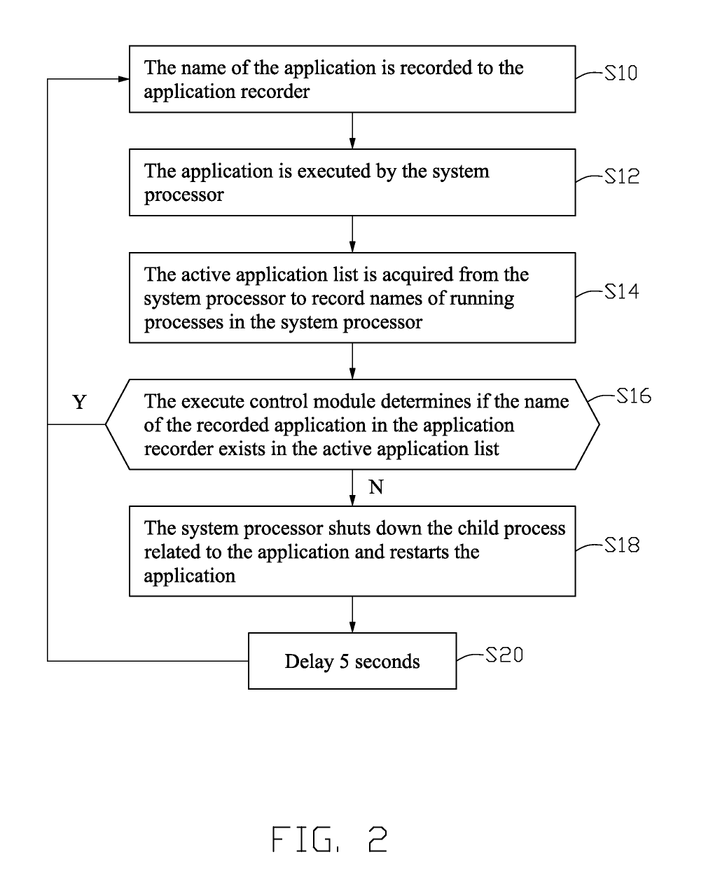

Referring to FIG. 2, a method for monitoring process in an embedded electronic device according to the embodiment includes the following steps.

In step S10, the name of the application 30 is recorded to the application recorder 50.

In step S12, the application 30 is executed by the system processor 10.

In step S14, the active application list 95 is acquired from the system processor 10 to record names of running processes in the system processor 10.

In step S16, the execute control module 70 determines if the name of the recorded application in the application recorder 50 exists in the active application list 95. If it does exist, go back to step S10; if does not exist, go to step S18.

In step S18, the system processor 10 shuts down the child process related to the application 30 and restarts the application 30.

In step S20, delay for a time period (e.g. 5 seconds) and go back to the step S10.

This method may be based on Linux system. The execute control module 70 will judge if monitored process needs to be restated or not. The execute control module 70 can monitor each process in the system processor 10, and restore the child process that terminated by unknown reasons. Even the execute control module 70 can be improved to restore the last status that child process exists.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method for monitoring a process in an embedded electronic device, the method comprising:
recording a name of an application from an application module to an application recorder;
executing the application by a system processor;
acquiring an active application list from the system processor;
determining if the name of the recorded application in the application recorder exists in the active application list; and
if the name of the recorded application does not exist, the system processor shuts down at least one child process related to the application.

2. The method of claim 1 further comprising restarting the application after shutting down the at least one child process.

3. The method of claim 1, wherein the application recorder is a random-access memory (RAM) disk.

4. The method of claim 1, wherein the system processor stores an available application list which can be executed by the system processor and the name of the application is in the available application list.

5. The method of claim 1, wherein the application module is a user interface (UI) module.

6. The method of claim 1, wherein the at least one child process, related to the application, is invoked by the system processor while executing the application.

7. A process management system of an embedded electronic device comprising:
a system processor capable of executing an application;
an application recorder capable of recording a name of the application before the system processor executing the application;
an active application monitor capable of recording names of running processes in the system processes;
an execute control module capable of determining if the name of the recorded application in the application recorder exists in the active application list after the application is executed; and if the recorded application does not exist, the system processor capable of shutting down at least one child process related to the application.

8. The process management system of claim 7, wherein the system processor is capable of restarting the application after shutting down the at least one child process.

9. The process management system of claim 7, wherein the application recorder is a random-access memory disk.

10. The process management system of claim 7, wherein the system processor stores an available application list which can be executed by the system processor and the name of the application is in the available application list.

11. The process management system of claim 7, wherein the application is a user interface application.

12. The process management system of claim 7, wherein the at least one child process related to the application is invoked by the system processor while executing the application.

13. A checking method for a process in an embedded electronic device comprising:
providing a system processor, the system processor capable of executing an application; an application recorder capable of recording a name of the application before the system processor executing the application; an active application monitor capable of recording names of running processes in the system processes; an execute control module capable of determining if the name of the recorded application in the application recorder exists in the active application list after the application is executed;
recording the name of the application to the application recorder;
executing the application by the system processor;
acquiring the active application list from the system processor;
determining if the name of the recorded application in the application recorder exists in the active application list; and
if the recorded application does not exist, the system processor shuts down at least one child process related to the application.
